(19) United States
(12) Patent Application Publication
(10) Pub. No.: US 2021/0362634 A1
(43) Pub. Date: Nov. 25, 2021

(54) DUCT ATTACHMENT MOLDED WITHIN A FOAM PAD

(71) Applicant: Magna Seating Inc, Aurora (CA)

(72) Inventors: Artur Stepanov, Auburn Hills, MI (US); Rene Chauvin, Desbarats (CA); Matthew Cook, Commerce Township, MI (US)

(21) Appl. No.: 16/631,038

(22) PCT Filed: Jul. 16, 2018
(86) PCT No.: PCT/US2018/042211

§ 371 Date: Jan. 14, 2020

Related U.S. Application Data
(60) Provisional application No. 62/532,548, filed on Jul. 14, 2017.

(51) Int. Cl. B60N 2/56; B60N 2/70

(52) U.S. Cl. CPC B60N 2/5642; B60N 2/70

(57) ABSTRACT

A duct attachment molded within a cellular foam pad is disposed between an air duct and an internal air flow channel of an automotive seat assembly for increasing the air flow between the air duct and the seat assembly. The duct attachment is insert molded within the foam pad which provides a mechanical connection and a seal between the duct attachment and the foam pad and reduces the potential for air leaks between the duct attachment and the foam pad.

### CROSS-REFERENCE TO RELATED APPLICATIONS

This application claims priority to U.S. Provisional Application No. 62/532,548, filed on Jul. 14, 2017.

### BACKGROUND OF THE INVENTION

### Field of the Invention

The present invention relates to a seat assembly in an automotive vehicle having a heating and cooling mechanism or device and an improved duct attachment between an air flow duct and the seat assembly. More particularly, the invention relates to a duct attachment flange molded within a cellular foam pad of the seat assembly, which eliminates the requirement for a seal between the duct attachment and the foam pad.

### 2. Description of Related Art

Automotive vehicles include one or more automotive seat assemblies having a seat cushion and a seat back for supporting a passenger or occupant above a vehicle floor. The seat assembly is commonly mounted to the vehicle floor by a riser assembly. The seat back is typically operatively coupled to the seat cushion by a recliner assembly for providing selective pivotal adjustment of the seat back relative to the seat cushion.

It is commonly known to provide an airflow duct attached to the seat assembly allowing air to pass through the seat assembly and towards the seat occupant for seat occupant comfort. For example, current duct systems are typically attached to a plenum bag within the seat assembly, which then spreads air to a multitude of holes in the trim cover that allows air to pass towards the occupant. The duct is typically attached to the plenum bag by heat-staking the duct or a duct flange to the plenum bag or by using some form of plastic clips and/or tabs. It is also known to provide an additional foam gasket between the duct outlet and the plenum bag to facilitate an airtight seal.

However, current systems rely on a seal from the duct to some sort of flange, and then from that flange to some form of plenum bag. The connections between the duct and the flange and between the flange and the plenum bag may leak air, which may reduce the air flow into and/or out of the seat assembly.

It is desirable, therefore, to provide a duct attachment molded within a foam pad, which eliminates one of the connections and the related potential for air leaks, by the molding of the flange directly into the foam pad. It is also desirable to provide a direct path from the duct to an air channel within the seat assembly. Further, it is desirable to provide an air flow system which does not require a plenum bag.

### SUMMARY OF THE INVENTION

A duct attachment molded within a cellular foam pad is provided between an air duct and an internal air flow channel of a seat assembly for increasing the air flow between the air duct and the seat assembly. The duct attachment is insert molded within the foam pad which provides a mechanical connection and a seal between the duct attachment and the foam pad and reduces the potential for air leaks between the duct attachment and the foam pad.

### BRIEF DESCRIPTION OF THE DRAWINGS

Advantages of the present invention will be readily appreciated as the same becomes better understood by reference to the following detailed description when considered in connection with the accompanying drawings wherein:

FIG. 1 is a perspective view of a related art duct connection between an air duct and a flange which is assembled with a plenum bag;

FIG. 2 is a cross-sectional perspective view of two air ducts, each air duct connected to a duct attachment molded within a foam pad having an air channel according to one embodiment of the invention;

FIG. 3 is a rear perspective view of a duct attachment flange according to the embodiment shown in FIG. 2;

FIG. 4 is a front view of the duct attachment flange according to the embodiment shown in FIG. 2;

FIG. 5 is an enlarged cross-sectional view of a duct attachment molded within a foam pad according to another embodiment of the invention;

FIG. 6 is a rear perspective view of the duct attachment according to the embodiment shown in FIG. 5; and

FIG. 7 is a front view of the duct attachment according to the embodiment shown in FIG. 5.

### DETAILED DESCRIPTION OF THE EMBODIMENTS

Referring to the Figures, like numerals indicate like or corresponding parts throughout the several views.

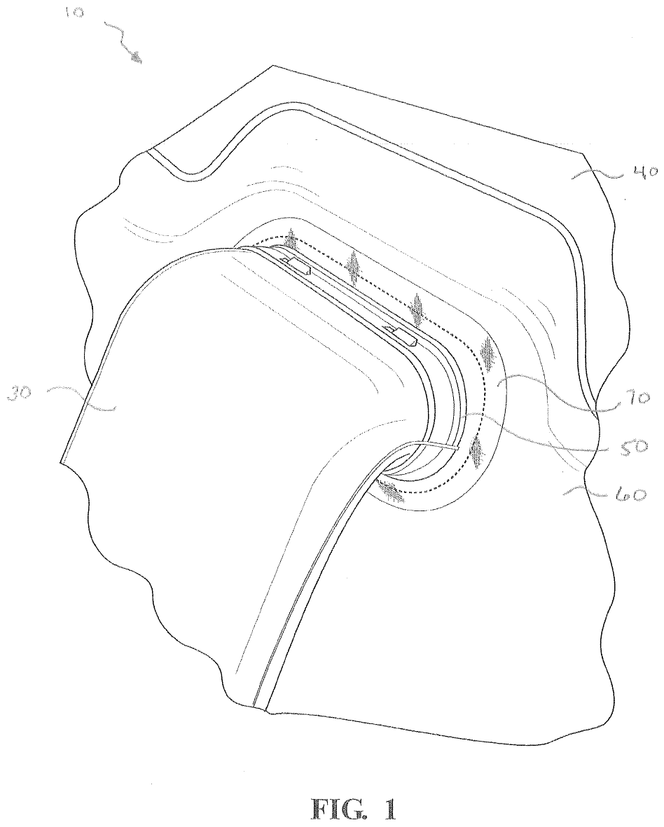

Referring to FIG. 1, a related art duct connection 10 is shown, which provides a connection and air flow between an air duct 30 and a portion of a seat assembly 40 for use in an automotive vehicle. This related duct connection 10 comprises the air duct 30, a flange 50, a plenum bag 60, and at least one seal and/or gasket 70 between the flange 50 and the plenum bag 60 to reduce air leaks. In accord with the above discussion, this known duct connection 10 utilizes the plenum bag 60 positioned within the seat assembly, which then spreads air to a multitude of holes in the trim cover that allows air to pass towards the occupant. In this regard, it is known to attach the flange 50 to the plenum bag 60 by heat-staking and the air duct 30 is in turn connected to the flange 50 by known connectors.

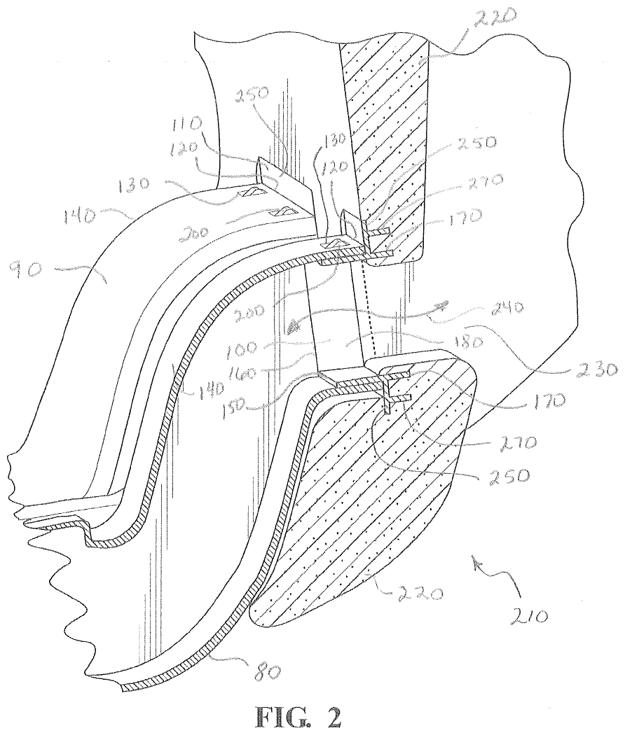

Referring to FIG. 2, an improved duct attachment system is shown, wherein a first air duct 80 and a second air duct 90 are shown connected to a first duct attachment 100 and a second duct attachment 110, respectively, according to one embodiment of the present invention. To permit removable joining of each air duct 80, 90 with its respective duct attachment 100, 110, each air duct 80, 90 comprises an air duct opening 120 having one or more fastener formations, preferably formed as slots and/or holes 130 in an outer duct wall 140 near the air duct opening 120. The attachment of such air ducts 80, 90 is disclosed in further detail below.

Each duct attachment 100, 110 comprises an attachment flange 150, a flange inlet 160 and a flange outlet 170 defined on inner and outer ends of the attachment flange 150, and at least one air flow port 180 passing through the attachment flange 150 in a longitudinal direction. The air flow port 180 essentially extends longitudinally between the flange inlet 160 and flange outlet 170. To permit joining of the air ducts 80, 90 to the respective duct attachment 100, 110, each attachment flange 150 further comprises one or more fastener formations preferably formed as clips and/or tabs 200 which may releasably engage the one or more slots and/or holes 130 in the outer duct wall 140 when the duct 80, 90 is assembled with the duct attachment 100, 110. Essentially, the clips/tabs 200 and slots/holes 130 define complementary fastener formations which removably join or mate together.

A duct attachment assembly 210 is formed when at least one duct attachment 100, 110 is insert molded within a cellular foam pad 220, which forms a part of the seat assembly. As shown in FIG. 2, the single cellular foam pad 220 is formed around two duct attachments 100, 110, although more or less duct attachments 100, 110 may be provided. The two duct attachments 100, 110 may be substantially identical or may have different configurations. The foam pad 220 further comprises at least one internal air channel 230, which preferably comprises part of a cooling system of a seat assembly. In this type of system, the seat assembly may comprise heat sinks from a thermoelectric cooling system positioned in air channels, wherein the air channel 230 serves to exhaust warm air from the seat. With the present invention, a plenum bag, gasket, and/or a seal may be omitted since the foam pad 220 forms an airtight seal around the duct attachment 100, 110 and air does not need to flow toward the occupant through a multitude of holes in the trim cover.

As shown in FIG. 2, when the air duct 80, 90 is operatively coupled with the duct attachment 100, 110, the air duct opening 120 is aligned with the at least one port 180 through the attachment flange 150 providing a direct air flow path 240 to the at least one air channel 230 within the foam pad 220.

Further, as shown in FIG. 2, each duct attachment 100, 110 forms a mechanical connection with the foam pad 220 wherein each duct attachment 100, 110 further may comprise a base 250 projecting transversely at an angle from the attachment flange 150 and one or more molding tabs and/or protrusions 270 extending at an angle from the base 250. The angle between the base 250 and the flange 150 may be substantially 90 degrees. Likewise, the angle between the molding tabs 270 and the base 250 may be substantially 90 degrees wherein the molding tabs 270 generally extend in the longitudinal direction and the base 250 extends separately or transverse to the longitudinal direction. However, these angles may be any desired or suitable angle. Each individual molding tab 270 may also include a hole or aperture to provide further mechanical connections with the foam pad 220.

More specifically as shown in FIG. 2, a portion of the attachment flange 150, a portion of the base 250, and a portion of one or more of the molding tabs and/or protrusions 270 may be embedded within the cellular foam pad 220 when the duct attachments 100, 110 have been insert molded within the foam pad 220. The cellular foam pad 220 may partially or fully encase a circumferential portion of the flange 150 and/or a circumferential portion of the base 250. Due to bonding of the pad material and the surfaces of the flange 150, base 250, and tabs 270, an additional seal or gasket may be omitted between the duct attachment 100, 110 and the foam pad 220 since the foam pad 220 forms a seal around the duct attachments 100, 110. Further, a plenum bag may be omitted since the foam pad 220 may contain at least one air channel 230 to exhaust warm air from the seat, as previously discussed.

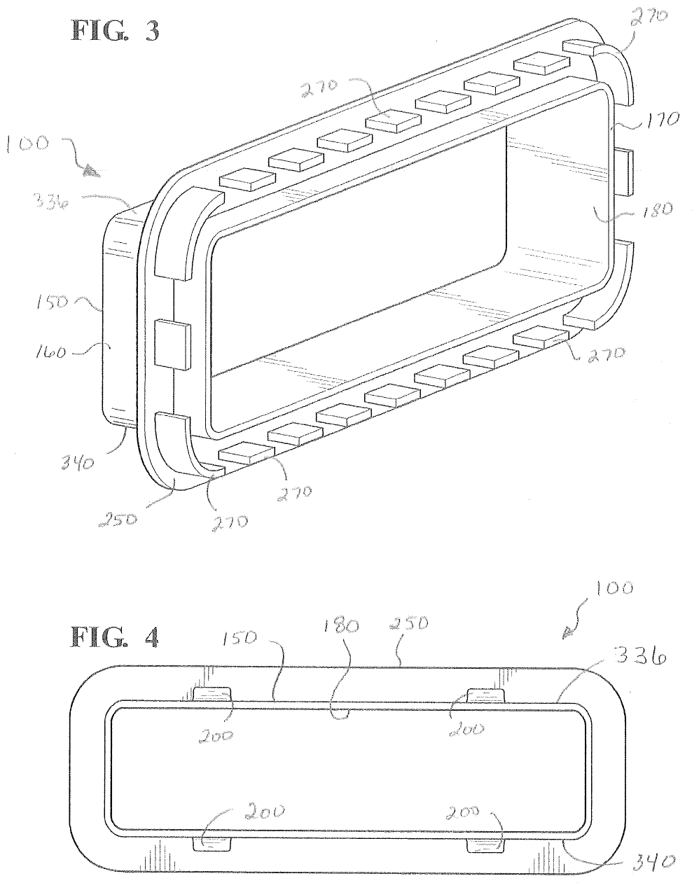

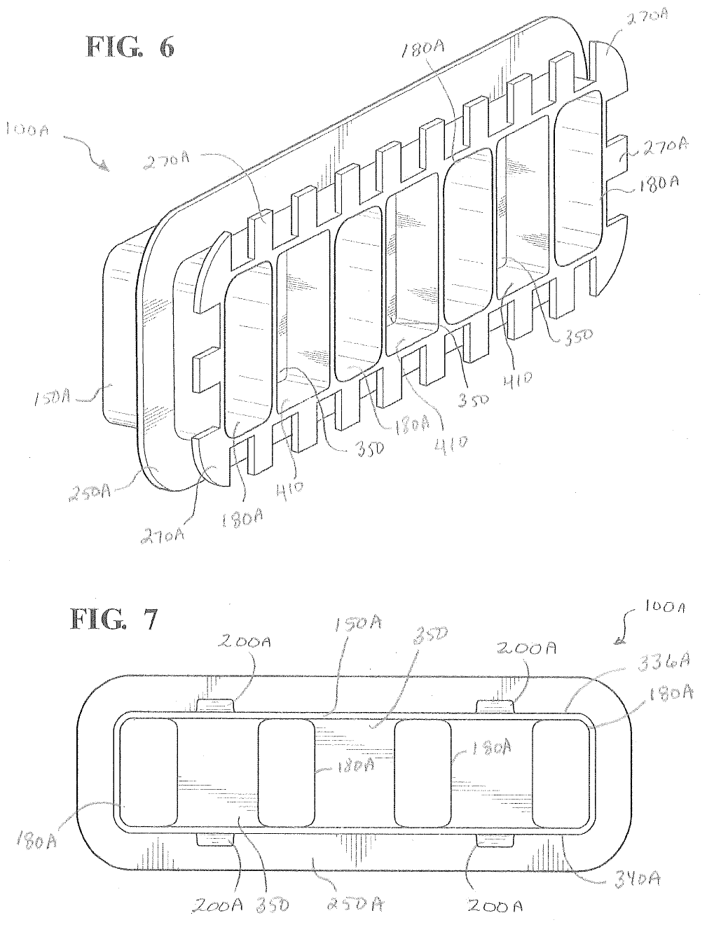

FIGS. 3 and 4 show the duct attachment 100 of the embodiment shown in FIG. 2 prior to being embedded in the foam pad 220. It will be understood that the duct attachment 110 has the same construction as duct attachment 100 such that a separate discussion thereof is not required. The duct attachment 100 may comprise the single air flow port 180, the base 250, the attachment flange 150 which may extend above and below the base 250, one or more molding tabs and/or protrusions 270 extending from the base 250, and one or more engagement tabs 200 (FIG. 4) on an upper portion 336 and/or a lower portion 340 of the flange 150. Two variants of tabs 200 are shown in the embodiments shown in FIGS. 4 and 7. The duct attachment 100 may have a plurality of molding tabs and/or protrusions 270, which may extend from the flange 150 and/or the base 250 and may have different shapes and/or sizes.

The attachment flange 150 essentially defines a peripheral wall that forms the periphery of the air flow port 180, wherein the air flow port 180 opens longitudinally from the flange inlet 160 and outlet 170 so as to communicate with the air duct 80, 90 and the air channel 230. The base 250 projects outwardly from the attachment flange 150 in a direction transverse to the longitudinal direction so as to lie in a face plane of the foam pad 220. In this embodiment, the tabs 270 are spaced peripherally from each other on one side of the base 250 and project longitudinally away from the base 250 so as to embed within the foam pad 220, which bonds thereto during the pad molding process.

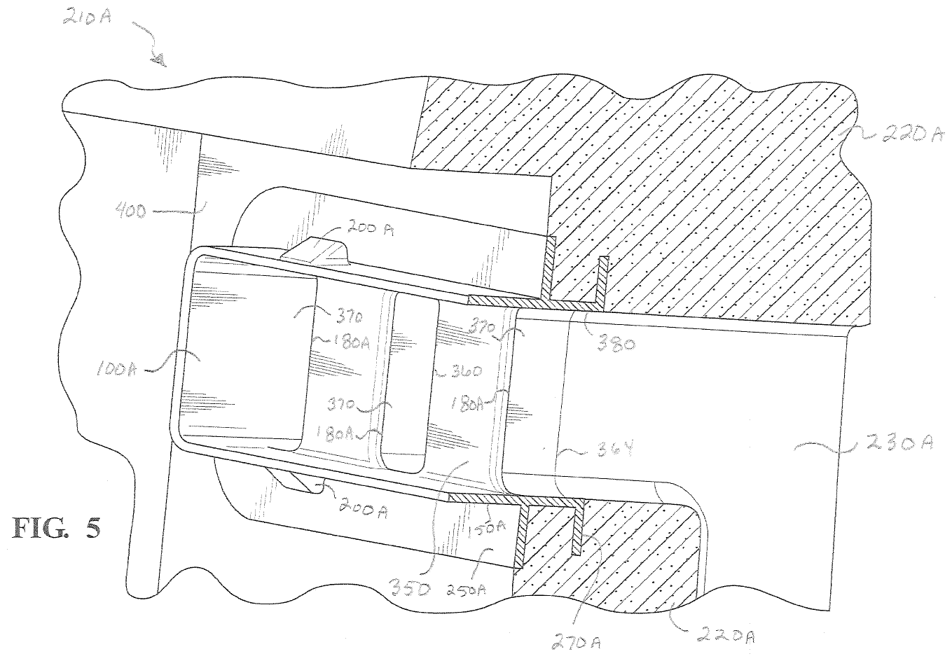

FIG. 5 shows an alternate embodiment of a duct attachment assembly 210a comprising a duct attachment 100a molded within a cellular foam pad 220a. As shown in FIGS. 5-7, the duct attachment 100a may comprise an attachment flange 150a extending in a longitudinal direction, a base 250a extending from the flange 150a at an angle, an internal divider wall 350, one or more engagement tabs 200a extending from the flange 150a to serve as fastener formations for joining to an air duct 80, 90 as described above, and one or more molding tabs and/or protrusions 270a extending from the flange 150a. In this embodiment, the tabs and/or protrusions 270a project transversely from an outer side of the flange 150a and preferably are generally parallel to the base 250a.

The duct attachment 100a shown in FIG. 5 may comprise one or more air flow ports 180a passing through the divider wall 350. The one or more air flow ports 180a further may comprise a port inlet 360, a port outlet 364, and port side walls 370 which may extend in the longitudinal direction terminating near the one or more molding tabs 270a. The duct attachment 100a may have individual ports 180a to coincide with holes in the foam pad 220a, or may have a single opening 380 to capture multiple ports 180a. An individual air flow port 180a may supply one or more air channels 230a through the foam pad 220a. Likewise, an individual air channel 230a may capture air flow through multiple air flow ports 180a. The duct attachment 100a may have a single air flow port 180a which may coincide with multiple holes 230a in the foam pad 220a.

As shown in FIG. 5, the duct attachment 100a having the attachment flange 150a is to be inserted into a foam tool (not shown) and molded directly into the foam pad 220a. The foam pad 220a may be formed around a portion of the air flow ports 180a, a portion of the base 250a, a portion of the flange 150a, and/or a portion of one or more molding tabs 270a. The duct attachment 100a may include a feature that will allow for a mechanical bond to the foam in order to resist tear-out. Holes, bent tabs, or other features (not shown) may be used to form the mechanical bond between the duct attachment 100a and the foam pad 220a in addition to the bonding between the foam material and the surfaces of the base 250a and tabs 270a. One or more air flow channels 230a may be formed within the foam pad 220a. The duct attachment 100a may be positioned in a recessed area 400 within the foam pad 220a.

Referring to FIG. 6, the duct attachment 100a may comprise one or more air flow ports 180a separated by cavities 410 wherein the air flow through the cavities 410 may be blocked by the internal divider wall 350. One or more molding tabs 270a may project from the flange 150a for forming a mechanical bond between the duct attachment 100a and the foam pad 220a.

Referring to FIG. 7, the duct attachment 100a may comprise the fastener formations preferably formed as one or more engagement tabs 200a protruding from the flange 150a. The one or more engagement tabs 200a may be on an upper portion 336a and/or a lower portion 340a of the flange 150a. The one or more engagement tabs 200a may snap into one or more slots and/or holes 130 in the air duct 80 as shown in FIG. 2. The current design shows simple snap features, but depending on the flange/duct geometry, other attachment methods and fastener formations are possible. Examples of alternate attachment methods are twist lock, clips, etc.

One benefit of the duct attachment 100a molded within the foam pad 220a is eliminating a sealing surface in the system, which reduces the potential for leaks. Additional benefits are a positive engagement between the duct and the flange, increased control over the sealing surface, and a reduced part count at assembly. Further, there is improved alignment between the ducts 80, 90 and air channels 230 in the foam.

The invention has been described in an illustrative manner, and it is to be understood that the terminology, which has been used, is intended to be in the nature of words of description rather than of limitation. Many modifications and variations of the present invention are possible in light of the above teachings. It is, therefore, to be understood that within the scope of the appended claims, the invention may be practiced other than as specifically described.

What is claimed is:

1. A duct attachment assembly adapted to connect an air duct to an internal air flow channel of an automotive seat assembly, said duct attachment assembly comprising:
a duct attachment comprising a duct attachment flange, a base extending at an angle from said flange, and one or more molding tabs; and
a cellular foam pad;
wherein a portion of said foam pad encases said one or more molding tabs.

2. The duct attachment assembly as set forth in claim 1, wherein said duct attachment flange comprising one or more engagement clips and/or tabs for assembly with an air duct having one or more slots and/or holes.

3. The duct attachment assembly as set forth in claim 2, wherein said one or more molding tabs extend from said base and/or said flange.

4. The duct attachment assembly as set forth in claim 3, wherein said flange extends above and below said base.

5. The duct attachment assembly as set forth in claim 4, wherein said flange is at least partially encased by said foam pad.

6. The duct attachment assembly as set forth in claim 5 further comprising an airtight seal between said flange and said foam pad.

7. The duct attachment assembly as set forth in claim 6, wherein said flange comprises a flange inlet, a flange outlet, and at least one port extending longitudinally through said flange.

8. The duct attachment assembly as set forth in claim 7, wherein said foam pad further comprises at least one air channel having a channel inlet aligned with at least one port through said flange.

9. The duct attachment assembly as set forth in claim 8, wherein said flange comprises more than one port through said flange.

10. The duct attachment assembly as set forth in claim 9, wherein each of said ports operatively connected to separate air channels within said foam pad.

11. A duct attachment assembly adapted to connect an air duct to an internal air flow channel of an automotive seat assembly, said duct attachment assembly comprising:
a duct attachment flange having a flange inlet, a flange side wall, a plurality of molding protrusions, and a first port extending longitudinally through said flange and having a first port outlet; and
a foam pad having an internal air flow channel, said foam pad encasing a circumferential portion of said flange side wall, encasing a circumferential portion of said first port outlet, and encasing said plurality of molding protrusions to form a mechanical bond with said flange.

12. The duct attachment assembly as set forth in claim 11, further comprising an airtight seal between said flange and said foam pad.

13. The duct attachment assembly as set forth in claim 12, wherein said flange having at least one engagement clip and/or tab on said flange side wall for releasably engaging an air duct outer wall.

14. The duct attachment assembly as set forth in claim 13, wherein said plurality of molding protrusions extend at an angle from said flange side wall.

15. The duct attachment assembly as set forth in claim 13, wherein said flange further comprises a base projecting at an angle from said flange side wall.

16. The duct attachment assembly as set forth in claim 15, wherein said plurality of molding protrusions extend at an angle from said base.

17. The duct attachment assembly as set forth in claim 13, further comprising a second port extending longitudinally through said flange separated from said first port by a port side wall.

18. The duct attachment assembly as set forth in claim 13, further comprising a plurality of ports extending longitudinally through said flange.

19. The duct attachment assembly as set forth in claim 18, wherein the flange further comprising an internal divider wall having openings for each of the plurality of ports.

20. A duct attachment assembly adapted to connect at least two air ducts to at least one internal air flow channel of an automotive seat assembly, said duct attachment assembly comprising:
a first duct attachment flange having a flange inlet, a flange side wall, a plurality of molding protrusions, and at least one port extending longitudinally through said first duct attachment flange;
a second duct attachment flange having a flange inlet, a flange side wall, a plurality of molding protrusions, and at least one port extending longitudinally through said second duct attachment flange;
a foam pad having at least one internal air flow channel, said foam pad encasing a circumferential portion of each duct attachment flange to form an air tight seal with each duct attachment flange; and
said foam pad encasing said plurality of molding protrusions of each duct attachment flange to form a mechanical bond with between said foam pad and said each duct attachment flange.
